(19) United States
(12) Patent Application Publication
(10) Pub. No.: US 2021/0207303 A1
(43) Pub. Date: Jul. 8, 2021

(54) LAUNDRY PROCESSING MACHINE AND METHOD OF CONTROLLING SAME

(71) Applicant: LG ELECTRONICS INC., Seoul (KR)

(72) Inventors: Jongseok JUNG, Seoul (KR); Hyunjin KIM, Seoul (KR)

(21) Appl. No.: 16/070,750

(22) PCT Filed: Jan. 18, 2017
(86) PCT No.: PCT/KR2017/000597

§ 371 Date: Jul. 17, 2018

(30) Foreign Application Priority Data
Jan. 18, 2016 (KR) 10-2016-0005742

(51) Int. Cl. D06F 33/00; D06F 37/22

(52) U.S. Cl. CPC D06F 33/00; D06F 37/42; D06F 37/22

(57) ABSTRACT

A laundry processing machine according to the present invention includes a plurality of washing units that implement washing independently from each other. When the plurality of washing units implement washing simultaneously, the laundry processing machine detects the vibration amount generated and control the motor rotation speed of each washing unit to decrease the vibration generated so that damage to the laundry processing machine can be prevented.

### TECHNICAL FIELD

The present invention relates to a laundry processing machine having a plurality of washing units, and more particularly, to a laundry processing machine for decreasing vibration generated during washing, and a method for controlling the same.

### BACKGROUND ART

Generally, a laundry processing machine is an apparatus that processes laundry through various operations such as washing, spin-dry and/or drying. Such a laundry processing machine includes a laundry processing machine that washes laundry such as clothing or bedding by using the emulsifying action of the detergent, the water current action caused by the rotation of the washing tub or the laundry blade, and a mechanical force applied by the laundry blade, a dryer that applies a hot air or a cold air to dry the laundry, and a refresher that removes the wrinkles of the clothes by applying steam. In addition, a washer-drier provides a combination of various functions.

Vibration may be generated as a motor connected to the washing tub rotates during the washing operation of the laundry processing machine. Particularly, when a spin-dry process of the laundry processing machine is performed, the motor rotates rapidly, so that relatively large vibration may occur.

Recently, a laundry processing machine including a plurality of washing units independently performing washing has been under development. When a plurality of washing units perform washing simultaneously, the vibration generated in each washing unit may cause interaction to easily generate larger vibration. Thus, a technology for decreasing vibration in the laundry processing machine is under study.

### DISCLOSURE

### Technical Problem

It is an object of the present invention to provide a laundry processing machine, including a plurality of washing units that implement washing independently from each other, capable of decreasing a generated vibration, and a method for controlling the same.

### Technical Solution

In an aspect, there is provided a laundry processing machine including: a first washing unit which performs washing; a first controller which controls operation of the first washing unit; a second washing unit which is installed in a lower portion of the first washing unit to be in contact with the first washing unit, and performs washing independently; a vibration sensor which is disposed in a contact portion of the first washing unit and the second washing unit to detect vibration; and a second controller which decreases or stops rotation speed of a motor of the second washing unit, in response to the vibration detected by the vibration sensor, while the first washing unit and the second washing unit are performing washing respectively.

In another aspect, there is provided a method for controlling a laundry processing machine comprising a first washing unit and a second washing unit for performing washing independently of each other in a washing space, wherein the first washing unit is disposed above the second washing unit, the method including: a step of performing washing independently of each other by the first washing unit and the second washing unit according to an input setting; a detection step of detecting a vibration of a vibration sensor disposed in a contact portion of the first washing unit and the second washing unit; and a control step of decreasing or stopping rotation speed of a motor of the first washing unit or the second washing unit, in response to the vibration detected by the vibration sensor.

### Advantageous Effects

According to the laundry processing machine and the method for controlling the same of the present invention, the laundry processing machine, in the laundry processing machine having a plurality of washing units that implement washing independently from each other, when the plurality of washing units implement washing simultaneously, the laundry processing machine detects the vibration amount generated and controls the motor rotation speed of each washing unit to decrease the vibration generated so that damage to the laundry processing machine can be prevented.

### DESCRIPTION OF DRAWINGS

FIG. 1 is a perspective view illustrating a shape of a laundry processing machine according to an embodiment of the present invention.

FIG. 2 is a perspective view illustrating a shape of a laundry processing machine according to another embodiment of the present invention.

FIG. 3 is a block diagram illustrating a configuration of a laundry processing machine according to an embodiment of the present invention.

FIG. 4 is a diagram for explaining a contact portion in which a vibration sensor is disposed according to an embodiment of the present invention.

FIG. 5 is a diagram for explaining a structure of a vibration sensor according to an embodiment of the present invention.

FIG. 6 is a diagram for explaining a method of controlling a laundry processing machine according to an embodiment of the present invention.

### MODE FOR INVENTION

Hereinafter, preferred embodiments of the present invention will be described with standard to the accompanying drawings. In describing the present embodiment, the same designations and the same standard numerals are used for the same components, and further description thereof will be omitted.

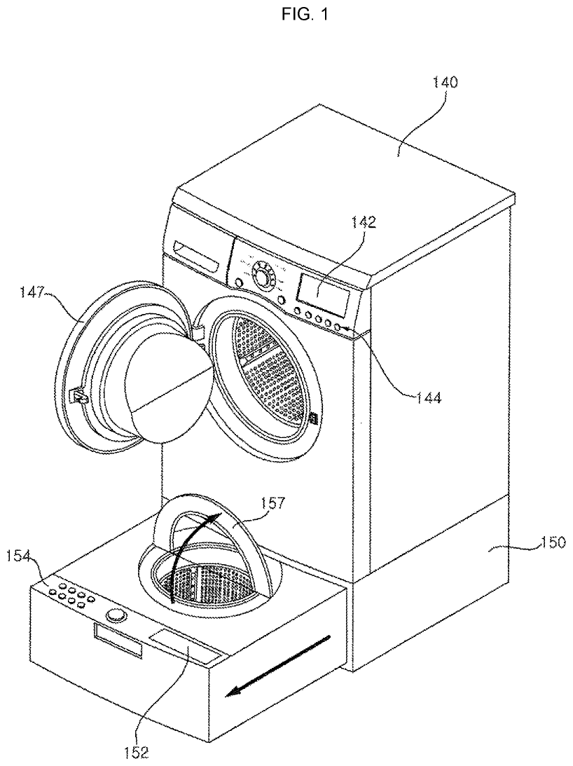

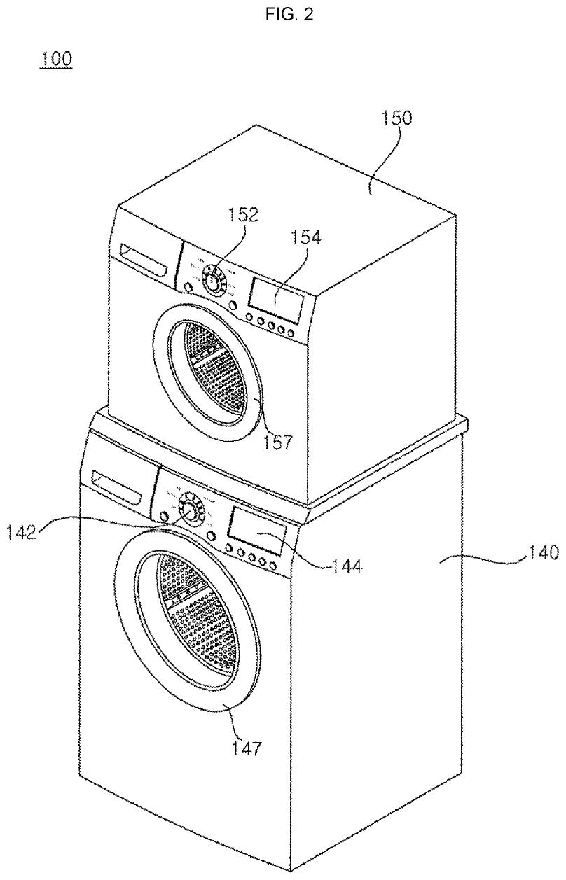

FIG. 1 is a perspective view illustrating a shape of a laundry processing machine 100 according to an embodiment of the present invention, and FIG. 2 is a perspective view illustrating a shape of a laundry processing machine according to another embodiment of the present invention.

Referring to FIG. 1, a laundry processing machine 100 includes a first washing unit 140 and a second washing unit 150.

The first washing unit 140 and the second washing unit 150 are disposed vertically. The first washing unit 140 is disposed in contact with the upper portion the second washing unit 150, and the first washing unit 140 and the second washing unit 150 can be coupled to and separated from each other.

The first washing unit 140 is in the form of a front load laundry processing machine, and the second washing unit 150 is in the form of a top load laundry processing machine.

The second washing unit 150 has a structure in which it is slidably opened and closed in the front and rear direction like a drawer. When the second washing unit 150 is pulled to the front, the upper end of the second washing unit 150 is exposed. A second input unit 154, a second display unit 152, and a second door 157 are disposed in the upper end of the second washing unit 150.

The first washing unit 140 may include a first input unit 144, a first display unit 142 and a first door 147. The second washing unit 150 may include the second input unit 154, the second display unit 152, and the second door 157.

The first washing unit 140 and the second washing unit 150 are provided with separate input units 144 and 154 and display units 142 and 152, so that a command can be input independently of each other and an operation corresponding to the inputted command can be performed.

The first washing unit 140 and the second washing unit 150 may respectively include a water storage tank for containing water, a tub 201, 202 which accommodates laundry and is rotatably installed in the water storage tank, a motor for rotating the tub, a water supply device for supplying water into the water storage tank or the tub, and a draining device for draining water in the water storage tank, and perform washing independently of each other.

FIG. 1 shows that the capacity of the tub of the first washing unit 140 is larger than the capacity of the tub of the second washing unit 150. However, the capacity of the tub of the first washing unit 140 may be equal to or smaller than the capacity of the tub of the second washing unit 150. The tub capacity of each of the washing units 140 and 150 is not limited.

The first washing unit 140 and the second washing unit 150 may be a washer-drier for simultaneously providing a washing function and a drying function.

The above described configurations of the first washing unit 140 and the second washing unit 150 may be provided in a general laundry processing machine, which can be obviously understood by those skilled in the art. Thus, a detailed description thereof will be omitted.

Referring to FIG. 2, both the first washing unit 140 and the second washing unit 150 are in the form of a front load washing machine. However, both the first washing unit 140 and the second washing unit 150 may be in the form of a top-load washing machine, and the shape of the first washing unit 140 and the second washing unit 150 are not limited.

In addition, in FIGS. 1 and 2, the second washing unit 150 is disposed below the first washing unit 140, but the second washing unit 150 may be disposed above the first washing unit 140.

When the first washing unit 140 and the second washing unit 150 provided in the laundry processing machine 100 perform washing respectively, the washing courses of the first washing unit 140 and the second washing unit 150 may include a washing process, a rinsing process, a spin-dry process, a drying process, and the like. In this case, when the motor of the first washing unit 140 and the motor of the second washing unit 150 are simultaneously rotated, an amplified vibration can be generated due to the interaction of the vibration generated by the motor rotation of the first washing unit 140 and the vibration generated by the motor rotation of the second washing unit 150.

Specifically, when any one of the first and second washing units 140 and 150 is in the unbalance state during washing to generate a vibration, the other is also in the unbalance state, thereby generating a vibration greater than each vibration. When such a large vibration occurs, the laundry processing machine 100 may be damaged.

Particularly, since the speed of motor rotation is fastest in the spin-dry process, when the first washing unit 140 and the second washing unit 150 simultaneously perform the spin-dry process, the laundry processing machine 100 is likely to generate a large vibration. In order to detect such a vibration, the laundry processing machine 100 further includes a vibration sensor which is disposed in a contact portion of the first washing unit 140 and the second washing unit 150 and detects a vibration.

In the present invention, when a large vibration is detected in the laundry processing machine 100 due to the simultaneous rotation of the motor of the first washing unit 140 and the motor of the second washing unit 150, at least one of two motor rotation speeds is decreased or stopped, thereby decreasing vibration. Hereinafter, each configuration for performing such an operation will be described in detail.

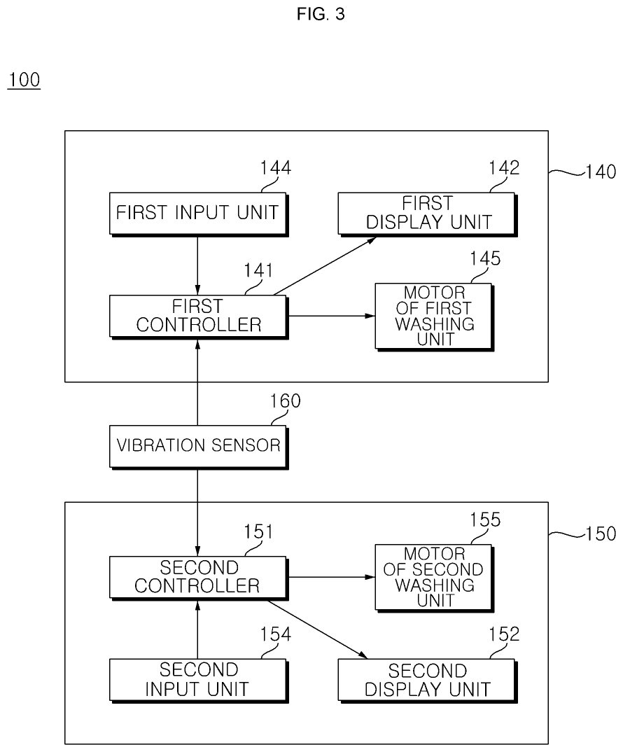

FIG. 3 is a block diagram illustrating a configuration of a laundry processing machine according to an embodiment of the present invention.

The first washing unit 140 includes a first input unit 144, a first display unit 142, a motor 145 for rotating the washing tub, and a first controller 141 for controlling the overall operation of the first washing unit 140 and the motor 145, and the second washing unit 150 includes a second input unit 154, a second display unit 152, a motor 155 for rotating the washing tub, and a second controller 151 for controlling the overall operation of the second washing unit 150 and the motor 155.

A vibration sensor 160 is disposed in a contact portion that is a portion where the first washing unit 140 and the second washing unit 150 are coupled to detect the vibration amount. The vibration sensor 160 transmits detected vibration amount information to the first controller 141 or the second controller 151.

The second controller 151 receives the vibration amount information from the vibration sensor 160 while the first and second washing units 140 and 150 perform the washing operation, and decreases or stops the rotation speed of the motor 155 of the second washing unit 150, in response to the detected vibration amount. In addition, the first controller 141 receives the vibration amount information from the vibration sensor 160 while the first and second washing units 140 and 150 perform the washing operation, and decreases or stops the rotation speed of the motor 145 of the first washing unit 140, in response to the detected vibration amount.

Specifically, the second controller 151 decreases the rotation speed of the motor 155 of the second washing unit 150, when the vibration amount detected by the vibration sensor 160 is equal to or greater than a set value. The second controller 151 continuously performs the washing without controlling the rotation speed of the motor 155 of the second washing unit 150, when the detected vibration amount is less than the set value.

The set value indicates the vibration amount to such an extent that the laundry processing machine 100 can be damaged. That is, when the vibration amount detected by the vibration sensor 160 is equal to or greater than the set value, it indicates that a vibration is generated to the extent that the laundry processing machine 100 can be damaged. At this time, when the second controller 151 decreases the rotation speed of the motor 155 of the second washing unit 150, the vibration generated in the second washing unit 150 is decreased, so that the vibration of the laundry processing machine 100 is decreased.

The first controller 141 may decrease the rotation speed of the motor 145 of the first washing unit 140, when the vibration amount detected by the vibration sensor 160 is equal to or greater than the set value, independently of the second controller 151. According to this embodiment, the vibration sensor 160 detects a vibration amount equal to or greater than the set value and transmits the detected vibration amount to the first controller 141 and the second controller 151. The first controller 141 and the second controller 151 decrease the vibration of the laundry processing machine 100 by simultaneously decreasing the rotation speed of the motor 145 of the first washing unit 140 and the rotation speed of the motor 155 of the second washing unit 150 respectively.

In addition, when the vibration amount detected by the vibration sensor 160 is equal to or greater than the set value after the second controller 151 decreases the rotation speed of the motor 155 of the second washing unit 150, the first controller 141 can decrease the rotation speed of the motor 145 of the first washing unit 140. To this end, the vibration sensor 160 transmits the detected vibration amount to the first controller 141 after the rotation speed of the motor 155 of the second washing unit 150 is decreased and the set time is elapsed. This is to decrease the vibration of the laundry processing machine 100 by decreasing the rotation speed of the motor 145, as a vibration enough to damage the laundry processing machine occurs even after the second controller 151 decreases the rotation speed of the motor 155 of the second washing unit 150.

The vibration sensor 160 transmits the detected vibration amount to the second controller 151 after the rotation speed of the motor 155 of the second washing unit 150 is decreased and the set time is elapsed. The second controller 151 stops the motor 155 of the second washing unit 150, when the vibration amount transmitted from the vibration sensor 160 is still equal to or greater than the set value after the rotation speed of the motor 155 of the second washing unit 150 is decreased and the set time is elapsed. This is to stop the motor 155 to decrease the vibration of the laundry processing machine 100, as a vibration enough to damage the laundry processing machine occurs even when the second controller 151 decreases the rotation speed of the motor 155 of the second washing unit 150.

The second controller 151 restores the rotation speed of the motor 155 to perform washing, when the vibration amount transmitted from the vibration sensor 160 is less than the set value after the rotation speed of the motor 155 of the second washing unit 150 is decreased and the set time is elapsed.

The vibration sensor 160 transmits the detected vibration amount to the second controller 151 after the motor 155 of the second washing unit 150 is stopped and the set time is elapsed. When the vibration amount transmitted from the vibration sensor 160 is less than the set value after the motor 155 of the second washing unit 150 is stopped and the set time is elapsed, the second controller 151 controls the motor 155 of the second washing unit 150 so that the second washing unit 150 performs washing again. This is to perform the washing operated by the second washing unit 150 again, since the vibration amount of the laundry processing machine 100 is decreased to some extent as the second controller 151 stops the motor 155 of the second washing unit 150.

When the detected vibration amount is still equal to or greater the set value after the motor 155 of the second washing unit 150 is stopped and the set time is elapsed, the second controller 151 maintains the stop state of the motor 155.

According to another embodiment of the present invention, the first controller 141 or the second controller 151 can determine whether the first washing unit 140 or the second washing unit 150 is in the unbalance UB state based on the vibration amount transmitted from the vibration sensor 160.

The second controller 151 may decrease or stop the rotation speed of the motor 155 of the second washing unit 150, when it is determined that the first washing unit 140 or the second washing unit 150 is in the unbalance UB state.

When it is determined that the first washing unit 140 or the second washing unit 150 is in the unbalance UB state, independently of the second controller 151, the first controller 141 can decrease or stop the rotation speed of the motor 145 of the first washing unit 140.

When it is determined that the first washing unit 140 or the second washing unit 150 is in the unbalance UB state according to the vibration amount detected by the vibration sensor 160 after second controller 151 decreases or stops the rotation speed of the motor 155 of the second washing unit 150, the first controller 141 can decrease or stop the rotation speed of the motor 145 of the first washing unit 140.

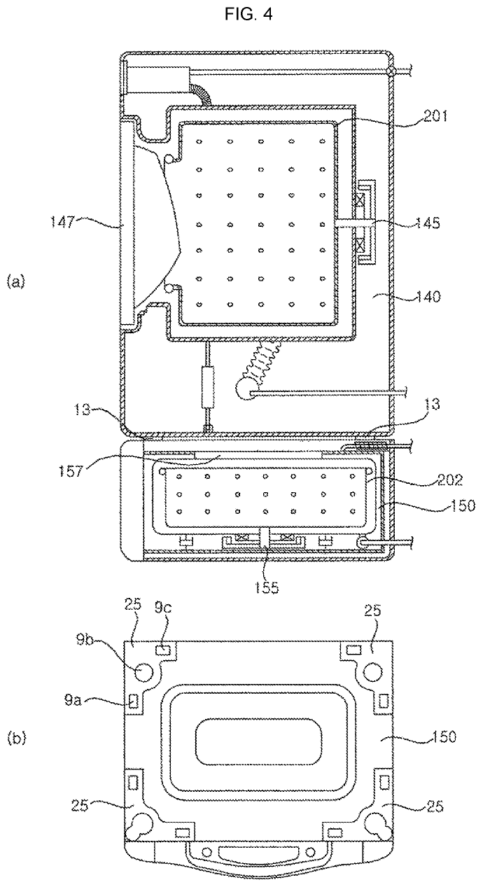

FIG. 4 is a diagram for explaining a contact portion in which a vibration sensor is disposed according to an embodiment of the present invention.

FIG. 4A is a sectional view of the laundry processing machine 100 according to an embodiment of the present invention. Referring to FIG. 4A, a plurality of legs 13 protruding from the back side of the first washing unit 140 toward the second washing unit 150 and supporting the first washing unit and a plurality of holes formed on the upper surface of the second washing unit 150 are coupled so that the first washing unit is fixed to the upper portion of the second washing unit. At this time, the plurality of legs 13 of the first washing unit and the plurality of holes of the second washing unit are coupled to form a contact portion. Accordingly, a plurality of contact portions exist.

FIG. 4B is a diagram illustrating an upper end of the second washing unit 150 according to an embodiment of the present invention. The contact portion is a portion where the protruded leg 13 of the first washing unit 140 and the hole 9a, 9b, 9c of the second washing unit 150 are coupled with each other. To this end, a plurality of brackets 25 for supporting the bottom surface of the first washing unit 140 may be provided in an upper end of the second washing unit 150. Each bracket 25 may be provided with the hole 9a, 9b, 9c corresponding to the protruded legs 13 of the first washing unit 140.

At least one of the first hole 9a, the second hole 9b, and the third hole 9c may be provided in a single bracket 25. At this time, at least one of the first hole 9a, the second hole 9b, and the third hole 9c provided in the bracket 25 may be coupled with the leg 13 of the first washing unit to form a contact portion. Accordingly, even when all of the first hole 9a, the second hole 9b, and the third hole 9c are formed in the bracket 25, one of the holes may be coupled with the leg of the first washing unit to form a contact portion.

Two or more contact portions may be generated as the leg 13 and the hole 9a, 9b, 9c are coupled. At this time, all of the contact portions may include a corresponding single vibration sensor 160, and at least one of the contacting portions may include the vibration sensor 160. Accordingly, at least one vibration sensor 160 may be provided.

For example, four brackets 25 may be provided at each corner of the upper end of the second washing unit 150, and three holes 9a, 9b, and 9c may be included in each bracket 25. At this time, at least four coupling portions may be formed, and a vibration sensor may be disposed in at least one of the four coupling portions.

When four legs 13 of the first washing unit 140 and at least four holes of the second washing unit 150 are provided, the four legs 13 are coupled to the hole of the second washing unit 150 to form four contact portions. At least one vibration sensor 160 may be disposed in the four contact portions. That is, four vibration sensors 160 corresponding to the four contact portions respectively may be provided, or a single vibration sensor 160 may be provided in only one of the four contact portions. The number of the contact portions and the number of the vibration sensors 160 are not limited.

As the leg 13 and the hole 9a, 9b, 9c are coupled with each other, the first and second washing units 140 and 150 are fixed and not separated during operation.

The vibration sensor 160 may be disposed in the contact portion of the first and second washing units 140 and 150 to detect a stack state of the first and second washing units 140 and 150.

The stack state of the first and second washing units 140 and 150 refer to a state where the first and second washing units 140 and 150 are coupled to each other. On the other hand, when vibration occurs in the laundry processing machine 100, the first washing unit 140 and the second washing unit 150 may be in the state of not being coupled instantaneously, and this state is referred to as a separation state.

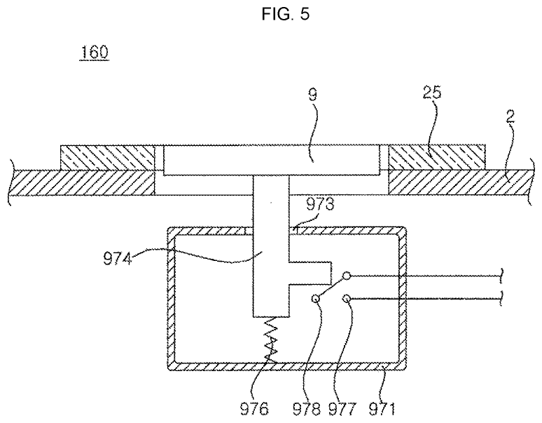

FIG. 5 is a diagram for explaining a structure of a vibration sensor according to an embodiment of the present invention.

The vibration sensor 160 includes a switch body 971 which is fixed inside a cabinet 2 of the second washing unit 150, a slider 974 which reciprocates inside the switch body 971, and a contact 977, 978 which is provided inside the switch body 971 and opens and closes a circuit (communication circuit or power circuit) by the slider 974.

The switch body 971 is provided with a body through hole 973 through which the slider 974 passes. The slider 974 is supported by an elastic support part 976 provided inside the switch body 971. Accordingly, when the first washing unit 140 is placed on the upper portion of the second washing unit 150, the slider 974 moves toward the contact 977, 978. When the first washing unit 140 is separated from the second washing unit 150, the slider 974 moves toward the direction away from the contact 977, 978.

The contact 977, 978 may include a first contact 977 which is fixed in the inside of the switch body 971, and a second contact 978 which is rotatably provided inside the switch body 971 and connected to the first contact 977 by the slider 974. When the first contact 977 and the second contact 978 are connected by the slider 974, the vibration sensor 160 detects that the first and second washing units 140 and 150 are in a stack state, and transmits this to the first controller 141 or the second controller 151.

The vibration sensor 160 can detect the stack state and the separation state of the first and second washing units 140 and 150 by detecting the stack state of the first and second washing units 140 and 150. In this case, at the start of washing, only when the stack state of the first and second washing units 140 and 150 is detected by the vibration sensor 160, the first controller 141 and the second controller 151 control the first washing unit 140 or the second washing unit 150 to perform washing. This is because the laundry processing machine 100 can be overturned or damaged, when the first washing unit 140 or the second washing unit 150 starts washing even though the first washing unit 140 and the second washing unit 150 are not in the stack state.

The vibration sensor 160 detects that the stack state and the separation state of the first washing unit 140 and the second washing unit 150 are repeated, during the washing operation of the laundry processing machine 100, so that the vibration generated in the laundry processing machine 100 can be detected. In this case, the vibration sensor 160 can detect the vibration amount of the laundry processing machine 100 by measuring the speed of repeating the stack state and the separation state of the first washing unit 140 and the second washing unit 150.

In another embodiment of the present invention, the vibration sensor 160 may include means for detecting a pressure, and can detect the vibration amount of the laundry processing machine 100 by detecting a pressure applied to the contact portion of the first and second washing units 140 and 150.

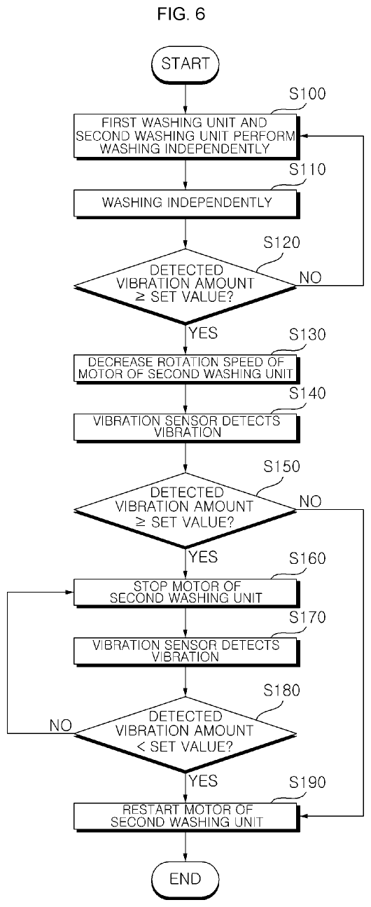

FIG. 6 is a diagram for explaining a method of controlling a laundry processing machine according to an embodiment of the present invention.

The first washing unit 140 and the second washing unit 150 included in the laundry processing machine 100 perform washing independently of each other according to an input setting (S100). The first washing unit 140 and the second washing unit 150 have an independent washing space respectively, and perform an independent operation corresponding to the setting inputted through the first input unit 144 or the second input unit 154.

When the first washing unit 140 and the second washing unit 150 simultaneously perform a fast rotation of the motor as in the spin-dry process, a large vibration may be generated in the laundry processing machine 100 due to the interaction of the rotation of the motor 145 of the first washing unit 140 and the rotation of the motor 155 of the second washing unit 150.

The vibration sensor 160 disposed in the contact portion of the first washing unit 140 and the second washing unit 150 detects the vibration generated in the laundry processing machine 100 (S110). The vibration sensor 160 transmits the detected vibration amount to the second controller 151.

The second controller 151 compares the vibration amount detected by the vibration sensor 160 with a set value. When the detected vibration amount is equal to or greater than the set value (S120), the second controller 151 decreases the rotation speed of the motor 155 of the second washing unit 150 (S130). The fact that the detected vibration amount is equal to or greater than the set value means that a large vibration is generated so that damage to the laundry processing machine 100 is likely to occur. Thus, the second controller 151 decreases the rotation speed of the motor 155 of the second washing unit 150, thereby decreasing the vibration of the laundry processing machine 100.

When the detected vibration amount is less than the set value, the second controller 151 continues the washing operation by the second washing unit 150 (S100). Even though vibration occurs in the laundry processing apparatus 100, when the occurred vibration is not enough to cause the damage to the laundry processing apparatus 100, the second controller 151 maintains the washing performance of the second washing unit 150.

After the rotation speed of the motor 155 of the second washing unit 150 is decreased and the set time is elapsed, the vibration sensor 160 detects again the vibration generated in the laundry processing machine 100 (S140), and transmits the detected vibration amount to the second controller 151.

The second controller 151 compares the vibration amount detected through the vibration sensor 160 again with the set value. When the detected vibration amount is equal to or greater than the set value (S150), the second controller 151 stops the motor of the second washing unit 150 (S160). The fact that the vibration amount detected after the rotation speed of the motor 155 of the second washing unit 150 is decreased and the set time is elapsed is equal to or greater than the set value means that the vibration of the laundry processing machine 100 is not decreased to such an extent that there is no risk of damage although the rotation speed of the motor 155 of the second washing unit 150 is decreased. Accordingly, the second controller 151 stops the motor 155 of the second washing unit 150 to decrease the vibration of the laundry processing machine 100.

The fact that the vibration amount detected after the rotation speed of the motor 155 of the second washing unit 150 is decreased and the set time is elapsed is less than the set value means that the vibration of the laundry processing machine 100 is decreased to a stable level as the rotation speed of the motor 155 of the second washing unit 150 is decreased. Accordingly, the second controller 151 controls the motor of the second washing unit 150 to restart so that washing is performed again (S190).

After the motor 155 of the second washing unit 150 is stopped and the set time is elapsed, the vibration sensor 160 detects again the vibration generated in the laundry processing machine 100 (S170), and transmits the detected vibration amount to the second controller 151.

The second controller 151 compares the vibration amount detected again through the vibration sensor 160 with the set value. When the detected vibration amount is less than the set value (S180), the second controller 151 restarts the motor 155 of the second washing unit 150 to perform the washing again (S190), since the vibration of the laundry processing machine 100 is decreased to a stable level as the motor 155 of the second washing unit 150 is stopped.

The second controller 151 maintains the motor of the second washing unit 150 in a stop state, when the vibration amount detected again by the vibration sensor 160 is equal to or greater than the set value (S160). Accordingly, the second controller 151 stops the motor 155 of the second washing unit 150 until the vibration amount detected again through the vibration sensor 160 becomes less than the set value.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

1. A laundry processing machine comprising:
a first washing unit which performs washing;
a first controller which controls operation of the first washing unit;
a second washing unit which is installed in a lower portion of the first washing unit to be in contact with the first washing unit, and performs washing independently;
a vibration sensor which is disposed in a contact portion of the first washing unit and the second washing unit to detect vibration; and
a second controller which decreases or stops rotation speed of a motor of the second washing unit, in response to the vibration detected by the vibration sensor, while the first washing unit and the second washing unit are performing washing respectively.

2. The laundry processing machine of claim 1, wherein the vibration sensor is disposed in a contact portion of the first washing unit and the second washing unit to detect a stack state of the first washing unit and the second washing unit.

3. The laundry processing machine of claim 1, wherein the second controller decreases or stops the rotation speed of the motor of the second washing unit, when vibration amount detected by the vibration sensor is equal to or greater than a set value.

4. The laundry processing machine of claim 3, wherein the first controller decreases or stops the rotation speed of the motor of the first washing unit, when the vibration amount detected by the vibration sensor is equal to or greater than the set value.

5. The laundry processing machine of claim 4, wherein the first controller decreases or stops the rotation speed of the motor of the first washing unit, when the vibration amount detected by the vibration sensor after the second controller decreases or stops the rotation speed of the motor of the second washing unit is equal to or greater than the set value.

6. The laundry processing machine of claim 3, wherein the second controller stops the motor of the second washing unit, when the vibration amount detected through the vibration sensor, after the rotation speed of the motor of the second washing unit is decreased and a set time is elapsed, is equal to or greater than the set value.

7. The laundry processing machine of claim 6, wherein the second controller controls the second washing unit to perform washing again, when the vibration amount detected through the vibration sensor, after the motor of the second washing unit is stopped and the set time is elapsed, is less than the set value.

8. The laundry processing machine of claim 1, wherein the second controller decreases or stops the rotation speed of the motor of the second washing unit, when it is determined that the first washing unit or the second washing unit is in an unbalance state, in response to the detected vibration.

9. The laundry processing machine of claim 8, wherein the first controller decreases or stops the rotation speed of the motor of the first washing unit, when it is determined that the first washing unit or the second washing unit is in the unbalance state, in response to the detected vibration.

10. A method for controlling a laundry processing machine comprising a first washing unit and a second washing unit for performing washing independently of each other in a washing space, wherein the first washing unit is disposed above the second washing unit, the method comprising:
a step of performing washing independently of each other by the first washing unit and the second washing unit according to an input setting;
a detection step of detecting a vibration of a vibration sensor disposed in a contact portion of the first washing unit and the second washing unit; and
a control step of decreasing or stopping rotation speed of a motor of the first washing unit or the second washing unit, in response to the vibration detected by the vibration sensor.

11. The method of claim 10, wherein the control step comprises:
a comparison step of comparing vibration amount detected by the vibration sensor with a set value; and
a motor control step of decreasing or stopping the rotation speed of the motor of the second washing unit, when the detected vibration amount is equal to or greater than the set value.

12. The method of claim 11, wherein the motor control step comprises decreasing or stopping the rotation speed of the motor of the first washing unit, when the vibration amount detected by the vibration sensor is equal to or greater than the set value.

13. The method of claim 11, further comprising a motor stopping step of stopping the motor of the second washing unit, when the vibration amount detected through the vibration sensor is equal to or greater than the set value after the rotation speed of the motor of the second washing unit is decreased and a set time is elapsed.

14. The method of claim 13, further comprising a motor restarting step of controlling the second washing unit to perform washing again, when the vibration amount detected through the vibration sensor is less than the set value after the motor of the second washing unit is stopped and the set time is elapsed.

15. The method of claim 10, wherein the control step comprises:
a determination step of determining whether the first washing unit or the second washing unit is in an unbalance state, in response to the detected vibration; and
a motor control step of decreasing or stopping the rotation speed of the motor of the first washing unit or the second washing unit, when it is determined that the first washing unit or the second washing unit is in the unbalance state.
